(19) United States
(12) Patent Application Publication
(10) Pub. No.: US 2013/0170926 A1
(43) Pub. Date: Jul. 4, 2013

(54) LOADING SYSTEM FOR LOADING BULK MATERIAL FROM A BULK MATERIAL PRODUCTION PLANT ONTO A SHIP AND UNLOADING SYSTEM FOR LOADING BULK MATERIAL FROM A SHIP ONTO TRANSPORTERS

(71) Applicants: Malcolm Cartwright, Fronreute/Staig (DE); Harald Flügel, Meckenbeuren (DE); Rudolf Fühl, Weingarten (DE); Klaus-Peter Lang, Bad Waldsee (DE); Manfred Schädler, Ravensburg (DE); Lorenz Reich, Weingarten (DE); Bruno Zinser, Waldburg (DE); Christopher Schumacher, Ravensburg (DE); Stefan Ulmer, Tettnang (DE); Cornel Fuest, Ravensburg (DE); Egon Zechner, Weingarten (DE)

(72) Inventors: Malcolm Cartwright, Fronreute/Staig (DE); Harald Flügel, Meckenbeuren (DE); Rudolf Fühl, Weingarten (DE); Klaus-Peter Lang, Bad Waldsee (DE); Manfred Schädler, Ravensburg (DE); Lorenz Reich, Weingarten (DE); Bruno Zinser, Waldburg (DE); Christopher Schumacher, Ravensburg (DE); Stefan Ulmer, Tettnang (DE); Cornel Fuest, Ravensburg (DE); Egon Zechner, Weingarten (DE)

(73) Assignee: COPERION GMBH, Stuttgart (DE)

(21) Appl. No.: 13/821,854

(22) PCT Filed: Aug. 30, 2011
(86) PCT No.: PCT/EP2011/004351

§ 371 Date: Mar. 8, 2013

Related U.S. Application Data
(60) Provisional application No. 61/415,433, filed on Nov. 19, 2010.

(30) Foreign Application Priority Data
Sep. 9, 2010 (DE) 102010040528.0
Nov. 19, 2010 (DE) 10 2010 044 150.3
Nov. 19, 2010 (DE) 102010044150.3

(51) Int. Cl. B65G 67/60

(52) U.S. Cl. CPC B65G 67/606
USPC 414/139.4

(57) ABSTRACT

A loading system for loading bulk material from a bulk material production plant onto a ship has at least one stationary intermediate storage container for receiving the bulk material from the bulk material production plant. A first loading conveying device is used to convey the bulk material from the bulk material production plant into the intermediate storage container. A second loading conveying device is used to convey the bulk material from the intermediate storage container into the ship. An unloading system for loading bulk material from a ship onto transporters has a stationary intermediate storage container for receiving the bulk material from the ship. Two unloading conveying devices are used to convey the bulk material, from the ship into the intermediate storage container and, from the intermediate storage container into the transporters.

### CROSS-REFERENCES TO RELATED APPLICATIONS

This application claims the priority of German Patent Application, Serial No. 10 2010 040 528.0, filed Sep. 9, 2010, and of German Patent Application, Serial No. 10 2010 044 150.3, pursuant to 35 U.S.C. 119(a)-(d), the content of which is incorporated herein by reference in its entirety as if fully set forth herein.

### FIELD

The invention relates to a loading system for loading bulk material from a bulk material production plant, in particular from a plastics material production plant, onto a ship
with at least one stationary intermediate storage container for receiving the bulk material from the bulk material production plant,
with at least a first loading conveying device for conveying the bulk material into the intermediate storage container,
with at least a second loading conveying device for conveying the bulk material from the intermediate storage container into the ship,
   and an unloading system for loading bulk material on a ship onto transporters
with at least one stationary intermediate storage container for receiving the bulk material from the ship;
with at least a first unloading conveying device for conveying the bulk material from the ship to the intermediate storage container,
with at least a second unloading conveying device for conveying the bulk material from the intermediate storage container into the transporters.

### BACKGROUND

The production sites for bulk material, in particular for plastics material, and the market for using the bulk material are often spatially a long way apart from one another. It is known from the prior art, to overcome these distances by the transportation of the produced bulk material, in particular the produced plastics material in bulk material form. Other bulk materials, in particular bulk material granules, are suitable for transporting by ship.

A loading system for loading bulk material from transporters onto a ship and an unloading system for loading bulk material from a ship onto transporters are known from U.S. Pat. No. 7,278,811, U.S. Pat. No. 305,976, U.S. Pat. No. 3,352,606 and EP 1 623 941 A1.

### SUMMARY

An object of the present invention is to develop a loading system of the type mentioned at the outset in such a way that the loading takes place in a gentle manner for the bulk material.

This object is achieved according to the invention by a loading system, in which
the first loading conveying device is configured in such a way that a slow conveyance and/or dense phase conveyance and/or lean phase conveyance of the bulk material takes place by means of the first loading conveying device and/or
the second loading conveying device is configured in such a way that a slow conveyance and/or dense phase conveyance and/or lean phase conveyance of the bulk material takes place by means of the second loading conveying device.

It was recognised according to the invention that bulk material transportation within the loading system in the form of slow conveyance, in other words a conveyance of bulk goods plugs separated from one another by air cushions or in the form of dense phase conveyance, in other words a conveyance of the bulk material in the form of a highly loaded lean phase conveyance or flow conveyance, in other words a lean phase conveyance a flow conveyance having a high load, or also in the form of a lean phase conveyance, leads to particularly gentle bulk goods transportation.

A lean phase conveyance, a slow conveyance or a dense phase conveyance in the sense of this application is present when the conveying parameters “conveying pressure”, “end speed”, “starting speed”, “load” and “plug formation” satisfy the criteria which are given below for various conveying principles, namely for pressure conveyance, on the one hand, and for suction conveyance, on the other hand, and for two different bulk material types, namely for granules with an average grain size >500 μm and for powders with an average grain size <800 μm. The end product of a granulating process is called the granulate here. The width of a grain distribution is defined by a relative spacing of a particle size X10 and X90. X10 here is the particle size in comparison to which the particles of 10% of the weight of a sample quantity taken are smaller. X90 is the particle size here in comparison to which the particles of 90% of the weight of a sample quantity taken are smaller. This difference X90−X10 is related to a particle size X50, in other words the particle size, in comparison to which the particles of half a sample weight of a sample quantity taken are smaller. With a narrow grain distribution there applies (X90−X10)/X50<0.5. In addition there applies to a narrow grain distribution X90/X10<1.5. As soon as at least one of the two values is exceeded, there is no longer a narrow grain distribution, but a wide grain distribution.

Pressure conveyance granules (>500 μm, narrow grain distribution, granulated)

| | Lean phase | | Slow | | Dense phase | |
|---|---|---|---|---|---|---|
| | conveyance | | conveyance | | conveyance | |
| Conveying pressure | 0.2-6 | bar | 0.5-6 | bar | 0.4-4 | bar |
| End speed | 20-50 | m/s | 4-12 | m/s | 8-35 | m/s |
| Starting speed | 10-20 | m/s | 1-4 | m/s | 6-10 | m/s |

| | | | |
|---|---|---|---|
| Load | 0.01-25 | 3-80 | 10-60 |
| Plug formation | No | Yes | No |

A load in slow conveyance is, in particular, in the range between 3 and 80. A dense phase conveyance is unlikely to be established in the case of granules. Generally, a lean phase conveyance or a slow conveyance takes place there.

Suction conveyance granules (>500 μm, narrow grain distribution, granulated)

| | Lean phase | | Slow | | Dense phase | |
|---|---|---|---|---|---|---|
| | conveyance | | conveyance | | conveyance | |
| Conveying pressure | ≧−0.5 | bar | ≧−0.8 | bar | ≧−0.8 | bar |
| End speed | 20-50 | m/s | 4-12 | m/s | 8-30 | m/s |
| Starting speed | 10-20 | m/s | 1-8 | m/s | 6-10 | m/s |

| | | | |
|---|---|---|---|
| Load | 0.01-10 | 3-80 | 1-45 |
| Plug formation | No | Yes | No |

A load in slow conveyance is, in particular, in the range between 3 and 80. A dense phase conveyance is unlikely to be established in granules. Generally, a lean phase conveyance or a slow conveyance takes place there.

Pressure conveyance powder (<800 μm)

| | Lean phase | | Slow | | Dense phase | |
|---|---|---|---|---|---|---|
| | conveyance | | conveyance | | conveyance | |
| Conveying pressure | 0.2-6 | bar | 0.8-6 | bar | 0.8-4 | bar |
| End speed | 20-30 | m/s | 5-12 | m/s | 8-35 | m/s |
| Starting speed | 10-20 | m/s | 1-8 | m/s | 6-10 | m/s |

| | | | |
|---|---|---|---|
| Load | 0.01-10 | 3-45 | 1-100 |
| Plug formation | No | Yes | No |

A load in slow conveyance is, in particular, in the range between 3 and 45.

Suction conveyance powder (<800 μm)

| | Lean phase | | Slow | | Dense phase | |
|---|---|---|---|---|---|---|
| | conveyance | | conveyance | | conveyance | |
| Conveying pressure | ≧−0.5 | bar | ≧−0.8 | bar | ≧−0.8 | bar |
| End speed | 20-50 | m/s | 4-12 | m/s | 8-35 | m/s |
| Starting speed | 10-20 | m/s | 1-8 | m/s | 6-10 | m/s |

| | | | |
|---|---|---|---|
| Load | 0.01-10 | 3-45 | 1-60 |
| Plug formation | No | Yes | No |

A load in slow conveyance is, in particular, in the range between 3 and 45.

The pressure of the carrier gas in the region of feeding the bulk material for conveyance is given as the conveying pressure. The end speed is the speed of the carrier gas at the end of the respective conveying path. The starting speed is the speed of the carrier gas at the start of the respective conveying path, in other words at the site of feeding the bulk material. Plug formation is taken to mean a conveying state, in which carrier gas cushions form in the bulk material.

The load is defined here as the quotient of the mass of the bulk material conveyed with a specific carrier gas quantity and the mass of the carrier gas used for this purpose. The slow conveyance according to the invention or dense phase conveyance is present when this load has a value of at least 3, if, in other words, in a given conveying volume of the loading system, by which the bulk material is conveyed, the mass of the bulk material is at least three times as great as the mass of the carrier gas present in this conveying volume. If very long conveying paths are bridged by the loading system and these are greater than e.g. 800 m, a dense phase conveyance in the sense of the application is even present when the load falls below the value of three. Transportation of this type was previously not considered in the prior art because of the forces occurring with slow conveyance or dense phase conveyance or with the in particular highly loaded lean phase conveyance in the region of deflections. It was recognised according to the invention that these forces in the region of deflections in the loading/unloading path can not only be managed in the meantime in the stationary conveying sections of the loading system, but also at the interface between the harbour/ship. With the slow conveyance or dense phase conveyance or lean phase conveyance, a very large throughput of bulk material can be realised, so the loading system can be designed for a continuous operation, which corresponds to the production quantity of a bulk material production plant, in particular a plastics material production plant. Efficient transportation of bulk material, in which no large warehousing has to be undertaken, is the result. According to the invention, it is sufficient if at least one of the at least two loading conveying devices is equipped for slow conveyance or dense phase conveyance or lean phase conveyance. Of course the two, or if even more loading conveying devices are used in the loading system, all the loading conveying devices can be configured for slow conveyance or dense phase conveyance or lean phase conveyance. An average grain size of the bulk material to be loaded may be in the range between 10 μm and 10 mm, in particular in the range between 50 μm and 6 mm, for example in the range between 50 μm and 200 μm or in the range between 2 mm and 6 mm. In the slow conveyance or dense phase conveyance or lean phase conveyance, in the region of a product feed, in other words in the region of a combining of the bulk material with the carrier gas, a gas speed (starting speed) may be in the range between 1 m/s and 20 m/s, in particular in the range between 1 m/s and 8 m/s or in the range between 6 m/s and 20 m/s, for example in the range between 2 m/s and 3 m/s or in the range between 10 m/s and 15 m/s. At the end of a conveying line for slow conveyance or dense phase conveyance or lean phase conveyance, the gas speed (end speed) may be in the range between 4 m/s and 50 m/s, in particular in the range between 4 m/s and 12 m/s or in the range between 8 m/s and 50 m/s, for example in the range between 8 m/s and 10 m/s or in the range between 25 m/s and 30 m/s. The gas speed is predetermined as a function of the type of bulk material, of the conveying line diameter and of the conveying line length for slow conveyance or dense phase conveyance or lean phase conveyance. If granules are conveyed, the gas speed in the region of the product feed is, for example, in the range between 1 m/s and 5 m/s. At the end of the conveying line, the gas speed in the granule conveyance may be in the range to, for example, a maximum of 12 m/s. If a powder is conveyed, the gas speed in the region of a product feed may be e.g. in the range between 5 m/s and 25 m/s and at the end of the conveying line reach a gas speed of, for example, up to 50 m/s. It may be that no further plug formation is present in the region of the high gas speeds. With gas speeds at the end of the conveying line, which are below 15 m/s, there is a slow conveyance. There is generally a dense phase conveyance in the case of gas speeds above this. The greater a conveying line diameter and/or the longer a conveying line is, the greater the predetermined gas speed. The loading system can bridge the entire conveying path between the bulk material production plant and the ship. Alternatively, it is possible to bridge a part of the loading path by bulk material transporters, which are independent of the loading system, so the loading system bridges a transport path between an unloading site of the transporters and the ship. The loading system may have a plurality of intermediate storage containers. The bulk material for conveyance into the ship can be removed in parallel simultaneously from at least two of these intermediate storage containers. The bulk material for conveyance into the ship can also be removed simultaneously from three or even more of the intermediate storage containers. A loading system with such a plurality of intermediate storage containers, from which the bulk material can be removed in parallel for conveyance into the ship, is an important aspect of the invention regardless of the conveying method. Storage containers or intermediate storage containers of the loading system and/or of the unloading system can be matched to one another in the conveying path of the bulk material with regard to their storage capacity in such a way that during transportation of the bulk material between the bulk material production plant, the ship and the transporters, individual bulk material batches are not undesirably mixed with other batches. For this purpose, an automatic volume balancing can be implemented by means of the storage capacities of the storage containers and the intermediate storage containers. For example, the storage containers and the intermediate storage containers of the loading system and/or of the unloading system may be matched to one another in such a way that the containers are either the same size or the respective larger container has a storage capacity corresponding to an integral multiple of a storage capacity of the smaller storage container. The loading system can be configured in such a way that the at least one intermediate storage container is designed for a bulk material buffering. In this case, no simultaneous conveyance of the bulk material with the two loading conveying devices downstream of one another has to take place.

A weighing mechanism for weighing the bulk material before the conveyance into the ship, which can, in particular, be calibrated, allows good weight control of the bulk material quantity conveyed by the loading system. The weighing mechanism may be part of a documentation device, with the aid of which the path of the loaded bulk material is documented on the path through the loading system. The goal here is to be able to follow this bulk material path back in detail as far as possible. The weighing mechanism may also, in particular in cooperation with the documentation device, be used to specify a site distribution of the load on the ship. A non-uniform distribution of the load, which exceeds an imbalance measure, for example a difference of 2000 t between the load on one ship side and the load on the other ship side, transverse to the longitudinal direction of the ship, can thus be prevented from occurring.

A further object of the invention is to develop an unloading system of the type mentioned at the outset, so the bulk material can be conveyed in a gentle manner from the ship to transporters.

This object is achieved according to the invention by an unloading system, in which
the first unloading conveying device is configured in such a way that a slow conveyance and/or dense phase conveyance and/or lean phase conveyance of the bulk material takes place by means of the first unloading conveying device and/or
the second unloading conveying device is configured in such a way that a slow conveyance and/or dense phase conveyance and/or lean phase conveyance of the bulk material takes place by means of the second unloading conveying device.

The advantages of the unloading system correspond to those, which were already mentioned above with reference to the loading system. Lorries or railway wagons may be used as the transporters. Containers can also be used. The unloading system may have a sifter mechanism for sifting the bulk material conveyed by the unloading system. The two unloading conveying devices connected downstream of one another are configured such that a conveyance of the bulk material from the ship into the at least one intermediate storage container, on the one hand, and a conveyance of the bulk material from the at least one intermediate storage container into the transporters inevitably takes place simultaneously. The at least one intermediate storage container can thus be configured in such a way that it is not designed for bulk material buffering. The bulk material conveyance with the at least one second unloading conveying device may also take place gravimetrically.

The advantages of a weighing mechanism for weighing the bulk material before conveyance into the transporters correspond to those, which were already mentioned above in relation to the weighing mechanism of the loading system.

A plurality of weighing mechanisms, which are arranged at various positions of the conveying path, can also be used in the unloading system or in the loading system. This increases the weighing reliability.

A stationary control mechanism for controlling the first unloading conveying device reduces the demands on the control design of the ship. The unloading of the ship can then also be controlled from the shore. The stationary, harbour-side control mechanism can have a signal connection to open-loop and closed-loop control units and also to sensors and other measuring sensors of the ship. This signal connection may be cableless and/or cable-bound, it being possible in the latter case for a cable connection to be guided via the respective conveying device. When controlling the unloading process, the control mechanism, which is arranged on the harbour side, can emit signals, for example, to an air quantity control device, in particular to an air quantity control unit, which is arranged on the ship side. Metering devices at the exit of the ship-side bulk material storage containers may also have a signal connection to the harbour-side, stationary control mechanism.

A corresponding control mechanism may be used to control the loading conveying device.

The control mechanism provided on the harbour loading side and/or the harbour unloading side may be part of the documentation device, with the aid of which the path of the loaded bulk material is documented on the path through the loading system and through the unloading system. The documentation device may provide documentation, in which it is recorded which of the storage containers is filled with which bulk material load. Individual filling batches, so-called lots, can also be followed back with the aid of the documentation device on the path through the loading system and through the unloading system. The documentation device may ensure a batch identification of a bulk material batch conveyed by the loading system.

The loading system and/or the unloading system may have a degassing device, with which it is ensured that the storage containers, the intermediate storage containers and/or the conveying lines do not have a concentration of dangerous gases above predetermined limit values. Gaseous monomers of a conveyed polymeric bulk material are one example of this. A carrier air source for the loading system and/or the unloading system may be used here as components of the degassing device.

The loading system and/or the unloading system can be equipped with means preventing an atmospheric exchange between the interior of system components, on the one hand, and the environment, on the other hand. These means preventing the atmospheric exchange can be ensured by corresponding component seals, which may have pressure compensation means. Alternatively or additionally, it is possible to flush the components, which are to be protected from an atmospheric exchange, by means of a flushing unit. A carrier gas source of the loading system and/or the unloading system can in turn be used as the flushing gas source.

A cleaning mechanism for cleaning the at least one intermediate storage container prevents an unintentional contamination of the bulk material by residues in at least one intermediate storage container. The cleaning can take place exclusively with water. A single central water source may be provided, from which the washing water used for cleaning is then guided to the various cleaning points. The water can be supplied via cleaning nozzles to the at least one intermediate storage container. The washing water may, in particular, be recycled in a circuit after the cleaning has been completed, for the next cleaning process. Alternatively or additionally to cleaning the at least one intermediate storage container, the cleaning mechanism may also be used to clean conveying lines of the loading conveying device and/or the unloading conveying device. In a variant of the cleaning mechanism, the latter is used exclusively for cleaning the components connected to one another by conveying lines or a sub-selection of these components, but not for cleaning the entire conveying lines themselves.

A mixer insert comprised by the at least one intermediate storage container ensures that bulk material mixed at the outlet of the at least one intermediate storage container is present and is composed of bulk material fractions of the bulk material quantity poured in in total. As an alternative or in addition to a mixer insert of this type, a thorough mixing of the bulk material can be achieved in the presence of a plurality of intermediate storage containers arranged parallel to one another in that the bulk material is simultaneously removed from a plurality of these intermediate storage containers. As a result, it is possible, in particular, to mix together various grain size distributions, which are present in the various intermediate storage containers, from which the removal takes place. When a plurality of intermediate storage containers are present, bulk material can be removed from several of these intermediate storage containers, while a bulk material is poured into at least a further one of the intermediate storage containers.

A carrier air source or conveying air source for conveyance, which has a compressor network with a plurality of compressor mechanisms, can be scaled to the desired conveying capacity of the loading system and/or the unloading system.

A carrier air source being configured to be so efficient that a loading of the intermediate storage container (19; 67) with bulk material and removal of bulk material from the intermediate storage container (19; 67) are possible in parallel allows a parallel filling and unloading of the at least one intermediate storage container. The carrier air source may also, in particular, be used to supply the first unloading conveyor device of the unloading system.

An emergency uncoupling device, in which an emergency uncoupling mechanism for ensuring a connection which can be rapidly uncoupled in an emergency between the intermediate storage container and the ship, increases the safety of the loading system or the unloading system. The emergency uncoupling system may have a plurality of claws engaging behind connection flanges, which are released from a predetermined tensile force.

A conveying line course, comprising conveying lines,
which extend horizontally in an angle range between a 30° ascending gradient and a 45° descending gradient and/or
which extend vertically in an angle range of maximum of a 30° deviation from the vertical,
   has proven particularly advantageous for pneumatic conveyance and in particular for slow conveyance. With a corresponding horizontal or vertical course of conveying line portions or the total conveying lines, a particularly efficient pneumatic conveyance is the result. The loading system and the unloading system may have a conveying logistics system, with which documentation of the loaded bulk material and also a weight balancing of the bulk material loaded onto the ship is possible.

Independently of an incline of the conveying lines, internal walls of the conveying lines, which come into contact with the bulk material, may be smooth or, in an alternative configuration, rough in a defined manner. To implement internal walls, which are rough in a defined manner, of the conveying lines, the latter may, for example, be shot-blasted with balls. Shot-blasted surfaces are advantageous, in particular in the case of high conveying speeds, as an undesired formation of thin threads of the material of the bulk material, which are also known as angel's hair, and can occur in plastics bulk materials, is avoided. The tubes of the conveying lines may either be manufactured from cold-rolled, hot-rolled or extruded materials. The respective composition of the surfaces is selected depending on the conveying method and type of bulk material. In slow conveyance, a smooth surface may be used. In dense phase conveyance, a slightly roughened surface, for example a hot-rolled surface, may be used.

To parameterise the roughness, the parameter mean roughness index Ra according to DIN EN ISO 4287:1998 and averaged roughness depth Rz are used. The averaged roughness depth Rz is the mean value of five measured maximum profile heights. For cold-rolled materials, generally made of high-grade steel, there applies Ra<3 μm, in particular 0.5 μm<Ra<1.6 μm. For hot-rolled materials there applies 3 μm<Ra<20 μm, in particular 2 μm<Ra<20 μm. For shot-blasted surfaces there applies 30 μm<Rz<70 μm. For shot-blasted aluminium surfaces there applies, in particular, 40 μm<Rz<120 μm.

If a smooth surface of the tube interior walls is desired, seamless pressed aluminium may also be used. There applies, in particular, here 1 μm<Ra<5 μm.

The conveying lines of the loading conveying devices and/or the unloading conveying devices may have a plurality of individual lines running parallel to one another. Individual pipe lines for the carrier air supply or for the carrier air discharge may be arranged above or below the individual lines running parallel to one another for bulk material conveyance. In particular a 4+1 structure with four individual lines running parallel to one another for bulk material conveyance and a carrier air feed line or carrier air discharge line may be used here. Accordingly, a 5+1 structure or in general an X+1 structure may also be used, wherein X can have the value 2, 3, 4, 5, 6, 7, 8, 10 or even higher. The pipe lines for the carrier air feed or for the carrier air discharge may also be configured in total or in portions as flexible hose lines. This plurality of individual lines may be designed as a pipe package, in which slow conveyance and/or the dense phase conveyance and/or the lean phase conveyance of the bulk material takes place through a plurality of conveying pipes (116), which is guided in a pipe package (115; 120; 121; 124; 125; 127) of conveying pipes. A pipe package of this type may have the individual pipes in a densely packed, for example hexagonally packed, configuration.

A conditioning mechanism comprising a conditioning device for conditioning carrier gas or carrier air in the ship-side or harbour-side conveying components, may prevent explosions or undesired changes to a gas composition within the conveying components. The conditioning mechanism may contain a flushing device for flushing the conveying components with dry air. Nitrogen may also be used as the flushing gas. The conditioning mechanism may ensure a regular exchange of the gas volume in the interior of the conveying components.

At least one rotary valve as a conveying component of the first loading conveying device and/or the second loading conveying device has proven to be particularly suitable as the metering component or as the air separating member within the bulk material conveying path.

Embodiments of the invention will be described in more detail below with the aid of drawings

### BRIEF DESCRIPTION OF THE DRAWINGS

FIG. 1 schematically shows a loading system for loading bulk material from lorries onto a ship and an unloading system for loading bulk material from a ship onto lorries:

FIG. 2 schematically shows a loading system and the unloading system according to FIG. 1, details in particular of a cleaning mechanism for cleaning various storage containers for bulk material along the loading path being shown;

FIG. 3 shows, in a view similar to FIG. 2, a loading system for loading bulk material from lorries onto a ship and an unloading system for loading bulk material from a ship onto railway wagons.

FIG. 4 shows a cross section through a plurality of conveying pipes in the conveying path of the loading system and/or of the unloading system, which are arranged in the form of a pipe package, grouped around a central support frame, the pipe package being able to be used in a loading conveying device or in an unloading conveying device;

FIGS. 5 to 9 highly schematically show also in cross section and in a view similar to FIG. 4, further package variants of the conveying pipes in the pipe packages;

FIGS. 10 to 12 show further configurations of an unloading conveying device; and

FIG. 13 shows a view from the viewing direction XIII in FIG. 12.

### DETAILED DESCRIPTION

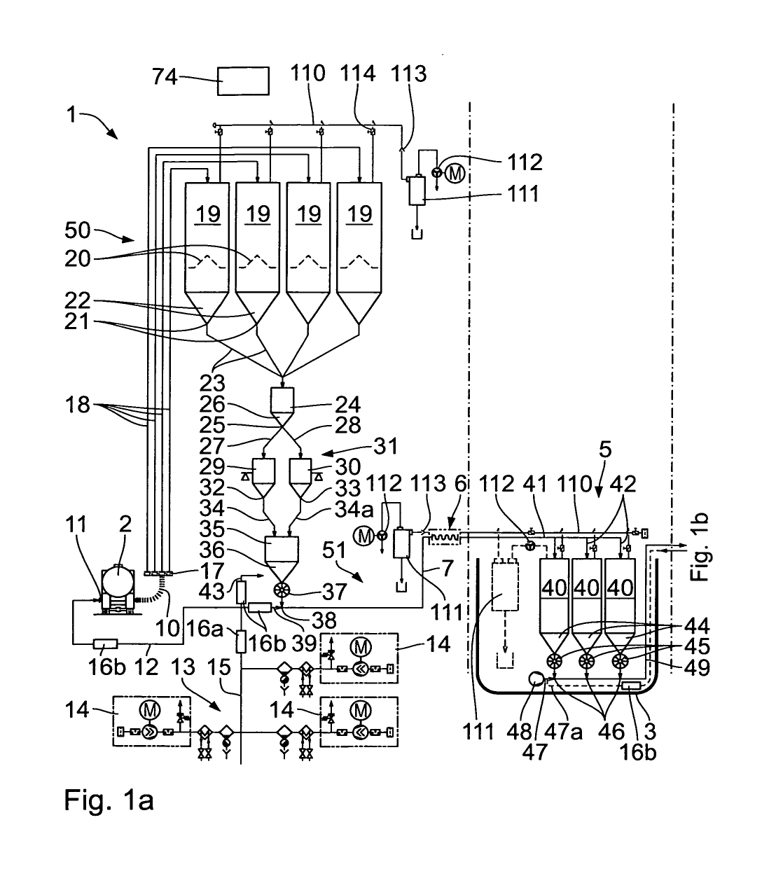

FIG. 1 schematically shows components which are used for the transportation of bulk material from a production plant to a destination a long way away from it. Conveyed as bulk material are plastics material granules, for example common mass plastics materials (polyolefins such as polypropylene (PP) or polyethylene (PE)) or other polymeric plastics materials, such as, for example, polyethylene terephthalate (PET) or polyethersulfone (PES) or polyester. Apart from bulk material in granule form, bulk material in powder form can also be conveyed, for example PTA (purified terephthalic acid) powder.

FIG. 1 is schematically divided into three system portions, which are separated from one another by dash-dot lines. Shown on the left is a loading system 1 for loading bulk material from transporters in the form of trucks or lorries 2 onto a ship 3. FIG. 1, on the right, shows an unloading system 4 for loading bulk material from the ship 3 onto transporters, again in the form of lorries 2. A ship system 5 is shown in FIG. 1 between the loading system 1 and the unloading system 4. The loading system 1 has a bulk material conveying connection with the ship system 5 by means of a shore to ship conveying device 6 with at least one conveying line 7. The ship system 5 has a bulk material connection with the unloading system 4 by means of a ship to shore conveying device 8 with at least one conveying line or a conveying pipe 9. The two conveying devices 6, 8 are designed in such a way that they can compensate ship movements relative to a stationary harbour component of the loading system 1 or the unloading system 4. With regard to the projecting design and overcoming a horizontal path, that which was already stated above for the conveying line or the conveying pipe 7 applies to the conveying line or the conveying pipe 9.

The bulk material is unloaded in the loading system 1 from lorries 2, which, in the form of tankers transport the bulk material from a production site to the loading system 1, by means of a flexible conveying line portion 10. This unloading takes place by means of slow conveyance. Basically, a dense phase conveyance or a lean phase conveyance can also be used. This basic possibility of replacing slow conveyance by dense phase conveyance or by lean phase conveyance may take place everywhere where slow conveyance is mentioned below in the description of the embodiments.

Each of the lorries 2 has a carrier gas connection 11, by means of which carrier gas, in the embodiment shown, air, is supplied via a carrier gas feed line 12 from a carrier gas source 13. The carrier gas source 13 is configured as a compressor network with a plurality of compressor mechanisms 14, of which three compressor mechanisms 14 are shown in FIG. 1, which feed a common main carrier gas feed line 15. The carrier gas is sucked in from outside by the compressor mechanisms 14 via suction filters, which are adapted to the surrounding conditions. One suction mechanism with a suction filter of this type can also be used for a plurality of compressor mechanisms 14. The filters in the carrier gas lines in each case have a differential pressure monitoring device, so it can be established when the filter bodies have to be serviced.

The carrier gas sucked in through the suction filter(s) firstly passes through a suction sound damper and then enters a compressor stage, driven by a main motor M. After the compressor stage, the compressed carrier gas passes through a pressure sound damper. In a sound hood, indicated by dashed lines, of each of the compressor mechanisms 14, there is also arranged a safety valve. After leaving the sound hood, the compressed carrier gas firstly enters a heat exchanger and then passes through a safety filter with an integrated water separator, before the compressed carrier gas is available in the main carrier gas feed line 15. A carrier gas supply from the main carrier gas feed line 15 into individual carrier gas feed lines 12 located downstream is controlled by an air quantity control device 16. The air quantity control device 16 has a pressure holding unit 16a arranged in the main carrier gas feed line and also local air quantity control units 16b for the downstream line sections. The air quantity control device 16 with the units 16a, 16b provides the loading system 1 with an adequate carrier gas quantity and an adequate carrier gas pressure at the feed point for the respective conveyance. A corresponding air quantity control device 16 with units 16a, 16b is also present in the unloading system 4.

An air quantity control unit 16b of its own for predetermining an air quantity in the respective carrier gas feed line may also be associated with each of the individual carrier gas feed lines, which branch off from the main carrier gas feed line 15.

The flexible conveying line portion 10 arranged downstream of the loading-side lorry 2 is connected by a gas-tight connection 17 to a stationary bulk material conveying line 18 of the loading system 1. The bulk material conveying line 18 has a bulk material conveying connection with an intermediate storage container 19 in the form of a storage hopper. The loading system 1 thus has a plurality of lorry connections 17, downstream of which respective stationary bulk material conveying lines 18 and their own intermediate storage containers 19 are arranged. The loading system 1 is shown in FIG. 1 with a total of four connections 17 and, correspondingly, four bulk material conveying lines 18 and four intermediate storage containers 19 arranged next to one another.

Each of the intermediate storage containers 19 has a mixer insert 20 indicated schematically and by dashed lines. The mixer insert 20 ensures that bulk material mixed at an outlet 21 of the respective intermediate storage container 19 is present, which is composed of bulk material fractions of the total bulk material quantity poured into the intermediate storage containers 19.

The respective intermediate storage container 19 tapers to the outlet 21 via a conical portion 22. A further conveying line portion 23 is arranged downstream of the respective outlet 21 in the bulk material conveying direction. The conveying line portions 23 associated with the various intermediate storage containers 19 join up in front of an intermediate collecting storage container 24. The intermediate collecting storage container 24 in turn has a conical portion 26 tapering at the base to an outlet 25. A conveying line following in the conveying direction branches at the outlet 25 of the intermediate collecting storage container 24 into two conveying line portions 27, 28. Each of the two conveying line portions 27, 28 opens into its own weighing container 29, 30, which is associated with this portion, of a bulk material weighing mechanism 31 of the loading system 1. The two weighing containers 29, 30 have a respective conical portion, which tapers toward an outlet 32, 33 of the respective weighing container 29, 30. From these outlets 32, 33, further conveying line portions 34, 34a lead to a further intermediate collecting storage container 35 arranged downstream of the weighing mechanism 31 in the bulk material conveying direction. As an alternative to the two weighing containers 29, 30 shown in FIG. 1a, only one single weighing container may also be provided between the intermediate collecting storage container 24 and the intermediate collecting storage container 35. A conical portion 36 tapering on the outlet side of the intermediate collecting storage container 35 opens into a rotary valve 37. The latter has a bulk material conveying connection on the delivery side with a carrier gas feed site 38. At the carrier gas feed site 38, a further carrier gas feed line 39 opens into the conveying line 7 for the slow conveyance of the bulk material by means of the shore to ship conveying device 6 into ship storage containers 40. From harbour-side components of the loading system or the loading conveying device 1 to the ship, the conveying pipe or the conveying line 7 can horizontally overcome a path of, for example, 10 m to 14 m. Along this path, the conveying line or the conveying pipe 7 may be designed to be projecting, in other words not supported on the base side. In each case, a ship-side conveying line portion 41, which is arranged downstream of the shore to ship conveying device 6, has a bulk material conveying connection via feed line portions 42 with a plurality of the ship storage containers 40, in the example shown, with three of the ship storage containers 40, in each case.

The loading system 1 may have a plurality of conveying groups with the connections 17, the bulk material conveying lines 18, the intermediate storage containers 19, the intermediate collecting storage containers 24 and 35 and the weighing containers 29, 30 in the arrangement which was described above in conjunction with FIG. 1. These other conveying groups not shown in FIG. 1 in the loading system 1, can be supplied in turn with carrier gas by means of the carrier gas source 13. This is indicated schematically in FIG. 1 by a further carrier gas feed line 43.

Conical portions 44 tapering on the base side, of the ship storage containers 40 in turn open out toward a respective rotary valve 45. The latter have a fluid connection on the delivery side via a carrier gas feed site 46 with a carrier gas feed line 47. The carrier gas source, which supplies the carrier gas feed line 47 with carrier gas, may be the carrier gas source 64. In this case, the carrier gas feed line 47 has a fluid connection with the main carrier gas feed line 15. This is shown by dashed lines in FIG. 1 by a carrier gas feed line portion 47a, which is also guided via the ship to shore conveying device 8. An air quantity control unit 16b of the air quantity control device is arranged in the carrier gas feed line portion 47a. As shown in FIG. 1, this air quantity control unit 16b can optionally be arranged on the ship side or on the loading harbour side. Even if the air quantity control unit 16b is arranged on the ship side, it can have a signal connection to the central control mechanism 75 of the unloading system 4 and be activated by it.

As an alternative or additionally, the ship system 5 may have its own carrier gas source 48, as shown in FIG. 1 using the example of a compressor. The feed sites 46 have a fluid connection via a further bulk material conveying line 49 and, during the unloading process, via the ship to shore conveying device 8, with the unloading-side conveying line 9.

The components of the loading system 1, which are used for the slow conveying of the bulk material from the lorry 2 to the intermediate storage containers 19 are designated, combined, the first loading conveying device 50. The components which are used for the slow conveyance of the bulk material from the intermediate collecting storage container 35 to the shore to ship conveying device 6 are combined as the second loading conveying device 51.

The carrier air source 13 is configured to be so efficient that a loading of the intermediate storage containers 19 with bulk material and simultaneously a removal of bulk material from the intermediate collecting storage container 35 is possible in parallel.

The conveying devices 6, 8 may have an emergency uncoupling mechanism, not shown in more detail in the drawing, for ensuring a rapid uncoupling in an emergency between the harbour-side conveying line 7 and the ship 3. This emergency uncoupling mechanism may have a plurality of claws engaging behind connection flanges of the conveying line 7, which is released from a predetermined tensile force, which is exerted on the main conveying device 6, 8 or on the conveying lines 7, 9. Other systems are also possible for fixing the conveying lines 7, 9 on the ship 3 by means of an emergency coupling mechanism, for example a connection via a ship-side or harbour-side coupling ball to a harbour-side or ship-side coupling ball receiver, the coupling ball receiver releasing the coupling ball from a predetermined tensile force. The emergency coupling mechanism may have a measuring and monitoring mechanism for measuring a coupling connection between the harbour-side conveying line 7 and the ship 3, in particular for measuring and monitoring a docking basket.

In the unloading system 4, an intermediate storage container 52 is arranged downstream of the conveying line 9. A conical portion on the base side of the intermediate storage container 52 opens into a further rotary valve 53. Arranged downstream from this is a sifter mechanism 54, with which various grain size fractions of the bulk material conveyed can be separated from one another. The sifter mechanism 54 is used to clean the bulk material conveyed. The sifter mechanism 54 is configured as a deflection counter-flow sifter. Alternatively, a horizontal flow bed sifter or another construction type of sifter can also be used. Only the conveying path of the heaviest bulk material fraction, which collects on the base of the sifter mechanism 54, is shown below. The sifter mechanism 54 in turn has, on the base side, a conical portion, which has a bulk material conveying connection on the delivery side with a further rotary valve 55. The latter has a bulk material conveying connection on the delivery side with an intermediate collecting storage container 56, two weighing containers 57, 58 and in turn a downstream intermediate collecting storage container 59. The weighing containers 57, 58 are part of an unloading-side weighing mechanism 61 of the unloading system 4, which is constructed and implemented in the manner of the weighing mechanism 31 of the loading system 1. Similarly to how this was already described above in conjunction with the loading system 1, only a single weighing container may also be arranged in the unloading system 4 instead of the two weighing containers 57, 58 between the intermediate collecting storage container 56 and the intermediate collecting storage container 59.

Alternatively or in addition it is possible to arrange the sifter mechanism 54 and/or the weighing mechanism 61 below unloading-side intermediate storage containers (compare containers 67 which are discussed below). In such case each storage container 67 may have his own sifter mechanism 54. The sifter mechanism 54 and/or the weighing mechanism 61 may be designed as drivable or mobile unit. Such drivable or mobile unit may be transferred between the respective containers 67 and may be placed where the respective trucks 2 are loaded. A plurality of such drivable or mobile units may be present to enable a simultaneous loading of a plurality of trucks 2.

Arranged downstream of the intermediate collecting storage container 59 in the bulk material conveying direction is a further rotary valve 62, which has a bulk material conveying connection on the delivery side to a feed site 63. The feed site 63 has a fluid connection with a carrier gas source 64 of the unloading system 4, which is equipped in the manner of the carrier gas source 13 of the loading system 1 with a plurality of compressor mechanisms 14, a main carrier gas feed line 15 and air quantity control devices 16.

Arranged downstream of the feed site 63 in the bulk material conveying direction is a further bulk material conveying line 65, which has a bulk material conveying connection via feed line portions 66 with a plurality of unloading-side intermediate storage containers 67, which are constructed in the manner of the intermediate storage containers 19 of the loading system 1. The intermediate storage containers 67 also have mixer inserts in the manner of the mixer inserts 20 of the loading-side intermediate storage containers 19. Outlets 68 at the base-side end of conical portions 69 have a bulk material conveying connection via branching bulk material conveying lines 70 with delivery connections 71 for connection to lorries 2 receiving the bulk material on the unloading side.

For unloading, the carrier gas feed line 47 on the ship-side may have a fluid connection with the unloading-side carrier gas source 64 via a carrier gas feed line and an air quantity control device. The carrier gas source 64 is in turn configured to be so efficient that an unloading of the ship storage containers 40 and a conveying of the bulk material after the weighing mechanism 61 to the bulk material storage containers 67 is possible in parallel.

Conveying components for the slow conveyance of the bulk material from the ship into the intermediate storage container 52 are combined as the first unloading conveying device 72. Conveying components for the slow conveyance of the bulk material from the intermediate collecting storage container 59 to the intermediate storage containers 67 and subsequently into the lorries 2 will be combined below as the second unloading conveying device 73.

A total of three intermediate storage containers 67 are shown in FIG. 1. As indicated by dashed lines in FIG. 1 by a further intermediate storage container, still further intermediate storage containers in the manner of the intermediate storage containers 67 may be provided.

The capacity of the carrier gas sources, 13, 64 is designed in accordance with the number of intermediate storage containers 19 of the loading system 1 or of the intermediate storage containers 67 of the unloading system 4 and in accordance with the conveyed bulk material quantity to be conveyed per time period.

The loading process is carried out by a central harbour-side, in other words stationary, control mechanism 74, which is shown schematically in FIG. 1 and which, in particular, controls the two loading conveying devices 50, 51.

The unloading process is controlled by a central harbour-side, in other words stationary, control mechanism 75, which is also shown schematically in FIG. 1. The control mechanism 75 controls, in particular, the two unloading conveying devices 72 and 73. The control mechanism 75 thus also centrally controls the unloading process from the ship to the intermediate storage container 52 by means of the ship to shore conveying device 8. The control mechanism 75 has a signal connection here via corresponding signal mechanisms with the ship-side components of the first unloading conveying device 72. This signal connection may be cable-bound and/or wireless.

The two control mechanisms 74, 75, may be components of a conveying logistics system.

The various conveying lines 18, 7, 41, 9, 65, in which the bulk material is conveyed by means of slow conveyance, in portions, run horizontally in an angle region between a 30° ascending gradient and 45° descending gradient, in particular between a 10° ascending gradient and a 30° descending gradient and/or vertically in an angle range of a maximum of a 30° deviation, in particular a maximum of a 10° deviation from the vertical. For example, the bulk material conveying line 18 is composed of a plurality of conveying line portions, which either run horizontally or vertically in the above described sense.

A bulk material transportation with the loading system 1 takes place as follows: A lorry 2 transporting bulk material drives to a loading site of the loading system 1. The lorry 2 is then weighed. The carrier gas feed line 12 is then connected to the lorry 2 and, with the aid of the flexible conveying portion 10, a bulk material conveying connection is produced between the lorry 2 and an associated one of the connections 17. Bulk material transportation from the lorry 2 into the intermediate storage container 19 associated with the respective bulk material conveying line 18 then takes place by means of pneumatic slow conveyance. After the lorry 2 has been unloaded, the lorry 2 is in turn weighed, so the weight of the unloaded bulk material can be determined by forming the weight difference. However, the weighing of the lorry 2 after the unloading may take place at an exit of the lorry 2 and does not have to take place at the unloading site itself. Bulk material is conveyed under the influence of gravity from the intermediate storage container 19 to the rotary valve 37. In this case, the bulk material is removed in parallel from various intermediate storage containers 19. No bulk material is removed at least from one of the intermediate storage containers 19. Bulk material can still be poured into this intermediate storage container 19 during the parallel removal from the other intermediate storage containers 19. In order to weigh bulk material to be loaded onto the ship 3, the bulk material is removed from the intermediate storage containers 19 by means of the intermediate collecting storage container 24 under the influence of gravity. The two weighing containers 29, 30 of the weighing mechanism 31 are then loaded, also under the influence of gravity, in an alternating manner with bulk material to be weighed. One of the two weighing containers 29, 30 is filled, in each case, in a continuous process, while the content of the other of the two weighing containers 29, 30 is weighed. The bulk material weighed in the weighing mechanism 31 is then removed by means of the further intermediate collecting storage container 35 and metered by means of the rotary valve 37 and supplied to the second loading conveying device 51. A pneumatic slow conveyance to the ship loading containers 40 then takes place by means of the shore to ship conveying device 6. For loading, the ship-side conveying portion 41 is connected by the shore to ship conveying device 6 to the harbour-side conveying line 7.

To control the slow conveyance during loading, the control mechanism 74 has a signal connection, in particular with the air quantity control devices 16 and the rotary valve 37 and with a distributing member, for example in the form of a conveying switch, not shown in FIG. 1, by means of which the alternating operation of the two weighing containers 29, 30 of the weighing mechanism 31 is ensured, and with the shore to ship conveying device 6. By means of the signal connection, weight data can be transmitted to the control mechanism 74 from the weighing mechanism 31 said weight data then being assigned to the respective currently loaded bulk material quantity units for documentation. The weight data can also be used to set up a ship's balance, so that, in particular, a uniform distribution of the bulk material is ensured in the ship 3 and, for example, a weight difference between the two mutually opposing sides in the travelling direction of the ship does not exceed a predetermined maximum difference value, which may, for example, be 2000 t.

When the bulk material is unloaded, the ship-side conveying line 49 is firstly connected by means of the ship to shore conveying device 8 to the harbour-side conveying line 9.

The carrier gas source 64 is also connected to the carrier gas feed line 47. Now, controlled by the control mechanism 75, a pneumatic slow conveyance of the bulk material from the ship storage containers 40 via the conveying line 9 and via the ship to shore conveying device 8 into the intermediate storage containers 52 takes place. The control mechanism 75 is therefore also used, in particular, to control the first unloading conveying device 72. A sifting of the bulk material takes place in the sifter mechanism 54 and a weighing of the bulk material takes place in the weighing mechanism 61, the weighing containers 57, 58 being alternately used, as already described above in conjunction with the weighing containers 29, 30 of the loading-side weighing mechanism 31. The function of the unloading-side weighing mechanism 61 with regard to the documentation corresponds to that which has already been described above in conjunction with the weighing mechanism 31. A conveying of bulk material under the influence of gravity takes place between the intermediate storage container 52 and the intermediate collecting storage container 59.

Conveying takes place between the intermediate collecting storage container 59 and the intermediate storage containers 67 by means of the second unloading conveying device 73 by means of pneumatic slow conveyance, in turn controlled by the central control mechanism 75. Unloading into the lorries 2 then takes place by means of the lines 70 and the connections 71 from the intermediate storage containers 67. As an alternative to unloading into lorries 2, unloading into containers or sacks is also possible.

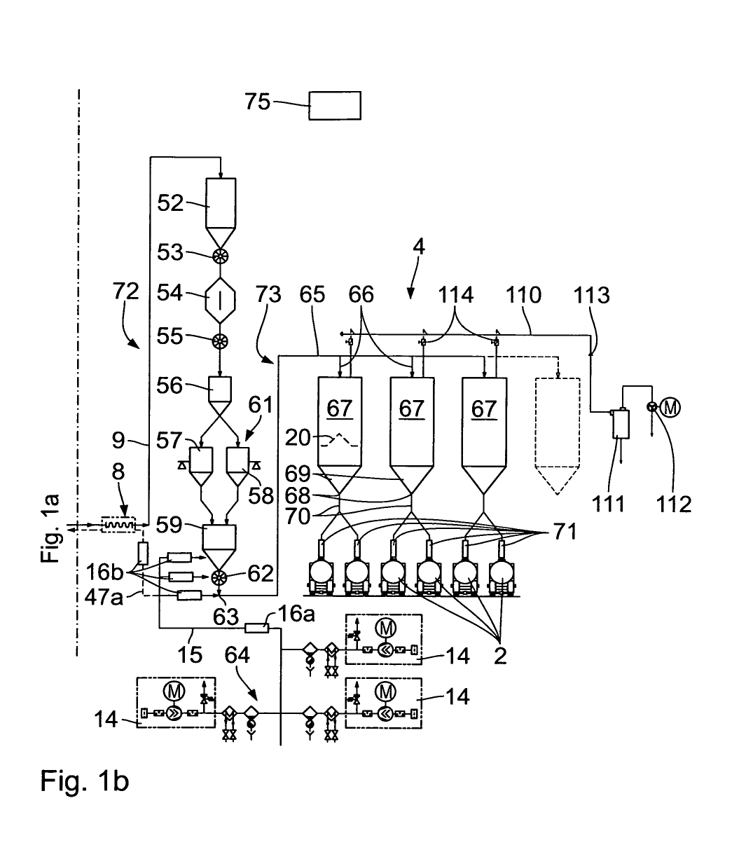

FIG. 2 shows details of a cleaning mechanism 76 for cleaning the various loading-side components conveying the bulk material, a cleaning mechanism 77 for cleaning the various ship-side components conveying the bulk material and details of a cleaning mechanism 78 for cleaning the unloading-side components conveying the bulk material.

The loading-side cleaning mechanism 76 has a washing water tank 79, from which by means of a driven pump 80, washing water is selectively conveyed via a main washing water feed line 81 to the bulk material-conveying components of the loading system 1. FIG. 2 indicates the branches 81a arranged downstream of the main washing water feed line 81 for supplying further conveying groups in the manner of those which were mentioned in the description of FIG. 1 in the loading system 1. Up to thirty conveying groups of this type can selectively be supplied with washing water by the washing water tank 79 and the pump 80.

The main washing water feed line 81 has a fluid connection by means of a conveying group washing water feed line 82 with the containers shown in FIG. 2, in other words with the intermediate storage containers 19, with the intermediate collecting storage container 24, with the weighing containers 29, 30 and the intermediate collecting storage container 35. The interior of these containers 19, 24, 29, 30, 35 can be reached by cleaning nozzles 83, which are in each case arranged at the end of line portions 84 associated with the containers 19, 24, 29, 30, 35 and branching off from the conveying group washing water feed line 82.

During the cleaning process, the washing water also flows through the bulk material conveying paths with the conveying line portions 23, the conveying line portions 27, 28 and the conveying line portions 34, 34a. The washing water collecting on the base-side during the cleaning in the intermediate collecting storage container 35 is discharged via a washing water discharge line 85 and optionally recycled for further use.

The ship-side cleaning mechanism 77 is according connected to a washing water tank 79, a pump 80, a main washing water feed line 81, branches 81a, a conveying group washing water feed line 82, cleaning nozzles 83, washing water line portions 84 and a washing water discharge line 85. The ship-side washing water discharge line 85 is configured as a collecting line, into which the washing discharge water lines associated with the ship storage containers 40 are combined. Arranged in the ship-side washing water discharge line 85 is a further pump 86. In the region of the ship-side cleaning mechanism 77, FIG. 2 shows details of a washing water preparation circuit 87 for reusing washing water already used for cleaning. Arranged downstream of the pump 86, for this purpose, in the washing water discharge line 85 is firstly a separator 88 for coarser bulk material fractions entrained with the washing water and then a filter 89 for entrained fine bulk material fractions. The bulk material fractions separated with the aid of the separator 88 and the filter 89 are collected in a container 90. The washing water cleaned by the separator 88 and the filter 89 is in turn supplied in a circuit line 91 via a further pump 92 to the ship-side washing water tank 79. A further fine material filter 93 is arranged between the water pump 92 and the washing water tank 79.

The unloading-side cleaning mechanism 78 also has a washing water tank 79, a pump 80, a main washing water feed line 81, branches 81a, a conveying group washing water feed line 82, cleaning nozzles 83, washing water line portions 84 and a washing water discharge line 85, in other words, with regard to the structure, corresponds to the loading-side cleaning mechanism 76. The interiors of the intermediate storage container 52, the sifter mechanism 54, the weighing containers 57, 58, the intermediate collecting storage container 59 and the intermediate storage containers 67 and the delivery connections 71 are accessible for cleaning via the washing water line portions 84 of the unloading-side cleaning mechanism 78 and the associated cleaning nozzles 83. The washing water discharge line 85 is configured as a collecting line, in which the washing water flowing out of the intermediate collecting storage container 59 and the delivery connections 71 after cleaning is firstly collected and then optionally supplied for recycling. During the cleaning the washing water flows after the cleaning of the interior of the conveying component respectively associated with the washing water line portion 84 until discharge into the washing water discharge line 85 along the bulk material conveying path.

If the storage containers to be cleaned with the cleaning mechanisms 76 to 78 have mixing inserts (cf mixing inserts 20 in the storage containers 19 or 67), at least one further one of the cleaning nozzles 83 may also be provided adjacent the mixing inserts.

The cleaning of the loading system 1, the ship system 5 and the unloading system 4 takes place in loading breaks when the conveying components have been emptied. The water used for cleaning with the aid of the cleaning mechanisms 76 to 78 is used without the addition of cleaning agents. Alternatively, a cleaning agent can also be added. Cleaning mechanisms, which correspond to the cleaning mechanisms 76 to 78, may, alternatively or additionally, be used to clean the conveying lines of the loading system 1, of the ship system 5 and the unloading system 4. It is alternatively possible to exclusively clean system components, which are connected to one another by means of the conveying lines, with the cleaning mechanisms 76 to 78, in other words to not specifically clean the conveying lines themselves completely.

A line system corresponding, in particular, to the lines 81, 81a and 84, can also be used in a degassing mechanism of the loading system 1, of the ship system 5 and the unloading system 4. The degassing mechanism has a suction unit, with which free volumes of the system components and/or of the conveying lines can be suctioned off, so that gases cannot undesirably form there in a concentration above a predetermined limit value. Alternatively or in addition, the degassing mechanism may have a flushing gas source, the system components of the loading system 1, the ship system 5 and the unloading system 4 then being able to be flushed to avoid undesired gas concentrations.

System components of the loading system 1, the ship system 5 and the unloading system 4 may be designed such that no atmospheric exchange takes place between gas volumes in the interior of the system components and the external environment. In order to ensure this, the system components may be sealed toward the external environment. At least some of the thus sealed system components may be connected to a pressure compensation unit, which is not shown in the drawing.

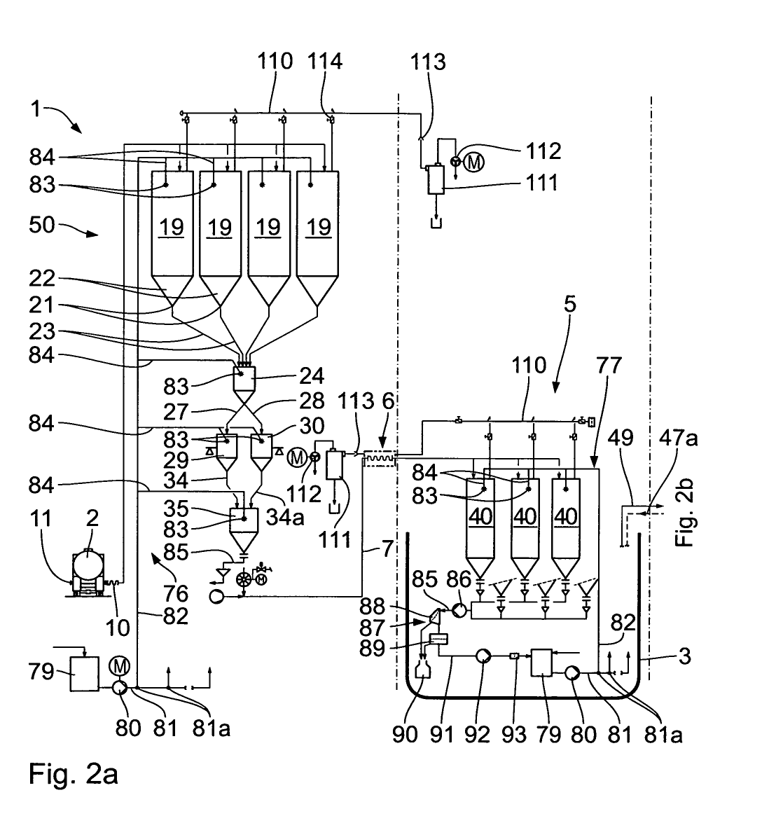

FIG. 3b shows in a view otherwise corresponding to FIG. 2b, an alternative configuration of an unloading system 94, which can be used instead of the unloading system 4 according to FIG. 1, in particular when the bulk material is to be loaded from the ship 3 not into lorries, but into railway wagons. One of these wagons 95 is indicated by dashed lines in FIG. 3b.

The bulk material conveying path up to and including the feed site 63 after the intermediate collecting storage container 59 corresponds, in the unloading system 94, to the structure and the arrangement in the unloading system 4.

The unloading system 94 will only be described below where it differs from the unloading system 4.

In the unloading system 94, the bulk material is conveyed in the conveying path after the intermediate collecting storage container 59 via a bulk material conveying line 96 during the pneumatic slow conveyance to a further intermediate storage container 97.

After the intermediate storage container 97, arranged in the bulk material conveying path of the unloading system 94 is a further weighing mechanism 98 with weighing containers 99, 100 and an intermediate collecting storage container 101, the function of which corresponds to that of the weighing mechanism 31 already described above and the weighing mechanism 61. As an alternative to the two weighing containers 99, 100 shown in FIG. 3b, only one single weighing container may also be provided. Arranged downstream of the intermediate collecting storage container 101 in the bulk material conveying direction is a rotary valve 102 and a bulk material distributor line mechanism 103. Between the rotary valve 102 and delivery connections 104, in the form of loading telescopes, in other words with conveying pipes which can be varied telescopically with respect to their length, a bulk material conveying line 105 in the bulk material distributor line mechanism 103 divides into a total of eight conveying line portions 106. Four of the adjacent discharge connections 104 are, in each case, associated with a wagon 95, so four loading chambers 107 of the wagon 95 arranged in the longitudinal direction of the wagon 95 can be loaded simultaneously by means of the bulk material distributor line mechanism 103. A loading weight for the loading chambers 107 and for the respective total wagon 95 can be predetermined by means of the weighing data of the weighing mechanism 98.

When the ship 3 is unloaded, the bulk material is firstly conveyed during the slow conveyance into the intermediate storage container 52, as already described above in conjunction with the unloading system 4. The following bulk material conveyance to the intermediate collecting storage container 59 also corresponds to that which was described above in conjunction with the unloading system 4. The bulk material is in turn transported for each slow conveyance from the feed site 63 to the intermediate storage container 97. For this purpose, the feed site 63 has a fluid connection via a carrier gas line 108 with the carrier gas source 64 shown only schematically in FIG. 3b. The bulk material is again weighed in the weighing mechanism 98 in the conveying path after the intermediate storage container 97. The bulk material conveying quantities associated with the individual wagons 95 are predetermined there.

The weighed bulk material is then supplied by means of the metering rotary valve 102 via the bulk material distributor line mechanism 103 to the wagons 95 for further transportation. In principle, the wagons 95 can also be used as intermediate storage containers of the unloading system 94.

The intermediate storage containers 19, for example, have a storage capacity of 600 t, in each case. The loading system 1 may, for example, have 80 such intermediate storage containers 19, which, as shown in the drawing, are combined into groups of four of the intermediate storage containers 19, in each case. Three of the four intermediate storage containers 19 have to be filled to load the ship 3, so the fourth of the intermediate storage containers 19 can also be filled during the loading of the ship 3.

The ship storage containers 40, for example, have capacity of 600 t in each case. The ship 3, for example, has a total of sixty of the ship storage containers 40, which, as shown in the drawing, are in each case combined into conveying groups, each with three of the ship storage containers 40.

The wagons 95 each have a capacity of about 60 t to 100 t.

In the unloading system 4, for example, sixty of the intermediate storage containers 67, each with a capacity of 600 t are in turn present.

Each of the ship storage containers 40 has a holding capacity of several hundred tonnes of the bulk material. The ship 3 has several dozens of these ship storage containers 40. The holding capacity and the number of intermediate storage containers 19 and of intermediate storage containers 67 approximately correspond to the number and the holding capacity of the ship storage containers 40.

In the embodiment shown, the intermediate storage containers 19 and the intermediate storage containers 67 have the same capacity.

The ship storage containers 40 may also have the same capacity as the intermediate storage containers 19. In practice, storage container groups of the ship storage containers 40, for example three of the ship storage containers 40, in each case, can be allocated to a storage container group of the intermediate storage containers 19. When loading the ship 3, three of the intermediate storage containers 19 of the harbour-side storage container group can then still be emptied to completely fill the associated storage container group of the ship storage containers 40, while, simultaneously a fourth of the intermediate storage containers 19 of this storage container group can already be filled again to then ensure a seamless filling of the next storage container group of the ship storage containers 40. In total, for example, twenty such storage container groups may be present on the ship 3 and the loading system 1.

When loading the wagons 95 by means of the unloading system 94, for example, forty of the wagons 95 can be loaded in parallel, the respective load of the wagons 95 being weighed by means of the respectively associated weighing mechanism 98. The weighing mechanism 98 is, in this case, not arranged under the wagon 95, but, as already described, in the bulk material conveying path above the wagons 95. In total, in the unloading system 94, twenty similarly constructed, unloading harbour-side component groups are then present, as shown in FIG. 3b using the example of a component group of this type. Four hundred of the wagons 95 can be loaded in a total unloading system of this type with twenty component groups in the manner of the unloading system 94, with about ten displacement processes.

The individual loads are distributed from the various ship storage containers 40 to the wagons 95 during the unloading process. Before and/or after the unloading, selected ones or all the components of the unloading system 94 can be cleaned with the unloading-side cleaning device 78.

The weighing mechanisms 31, 61 and 98, for example, have pressure cells as measuring sensors and can be calibrated. Instead of the weighing containers described, a coriolis weighing machine can also be used.

The loading system 1 is designed such that it has a bulk material conveying capacity which is adapted to the production capacity of the plastics material production plant, the production of which is to be conveyed. Overshooting production capacities may be filled into sacks, for example, independently of the bulk material loading of the ship 3 or loaded into containers.

To condition the carrier gas, each of the compressor mechanisms 14 has a cooler, a water separator and an in-line filter. Arranged along the carrier gas lines are additional water separators, in which condensate can be separated.

As an alternative to transportation to the connections 17 with the aid of the lorries 2, transportation directly from the plastics material production plant with the aid of a conveying system is possible, for example with the aid of a pneumatic conveying system, a hydraulic conveying system or a conveyor belt. Rail-bound wagons may also be used as the transporter to the loading system 1.

Additional line switches, line valves or filling level sensors may have a signal connection with the controls 74, 75 to control or monitor the conveyance.

In a variant of the unloading systems 4 and/or 94, not shown, all the conveying components of these unloading systems 4, 94 after the intermediate storage container 52 are arranged one above the other in such a way that an intermediate slow conveying section can be dispensed with. In this case, the second unloading conveying device 73 is dispensed with. The container 52 is then the highest point of the unloading system 4 and/or 94. All the components after the intermediate storage container 52 are then arranged below it.

Depending on the weighing result of the weighing mechanism 98, a distribution of the bulk material conveyed into the wagons 95 by the bulk material distributor line device 103 can be predetermined by means of the control mechanism 75, for example by means of a corresponding valve control within the bulk material distributor device 103 and a distributor, not shown in the drawing, or a distributing and scattering device in the form of a spreader in the wagon.

FIGS. 1 to 3 also show details of an exhaust air or exhaust gas conditioning device for the controlled disposal or treatment of the carrier gas after the conveying path thereof.

Carrier gas exhaust air which collects in the intermediate storage container 19 as a result of the pneumatic conveyance through the bulk material conveying line 18, is removed by means of an exhaust air collecting line 110 and fed to a separator 111 for solid material fractions, which are contained in the exhaust air. The exhaust air cleaned by the separator 111 is suctioned off by a fan or ventilator 112 and discharged to the atmosphere. A negative pressure holding unit 113, which is also designated a zero point, ensures that the negative pressure introduced into the exhaust air collecting line 110 is not fallen below. Feed line portions, which lead from the exhaust air collecting line 110 to the individual intermediate storage containers 19, can be automatically opened and closed by flaps 114.

Corresponding exhaust air-conditioning devices are provided in the ship storage containers 40 of the ship 3 and in the intermediate storage containers 67 of the unloading system 4. Components of the exhaust air-condition device, which correspond to those which have already been described above in conjunction with the exhaust air-conditioning of the loading system 1, have the same reference numerals and will not be described again in detail.

An exhaust air collecting line 110, which leads from the ship storage containers 40, can selectively be connected to the shore to ship conveying device 6 or to the ship to shore conveying device 8. This connection to the ship to shore conveying device 8 is not shown in more detail in the drawing.

As an alternative to the harbour-side separation of solid material fractions from the carrier gas exhaust air, this can take place on the ship. Corresponding components 111, 112 of a ship-side exhaust air-conditioning device of this type are shown by dashed lines in FIG. 1a. The above-described harbour-side exhaust air-conditioning of the ship storage containers 40 can then be dispensed with. Alternatively, each of the ship storage containers 40 may have their own exhaust air-conditioning device.

Instead of the separator 111a filter can also be used in the respective exhaust air collecting line 110. Each of the containers, in particular each of the ship storage containers 40, may have their own filter of this type.

The separator 111 or the filter that can optionally be used at this point is not arranged on the ship but on the harbour side to condition the exhaust air removed from the ship.

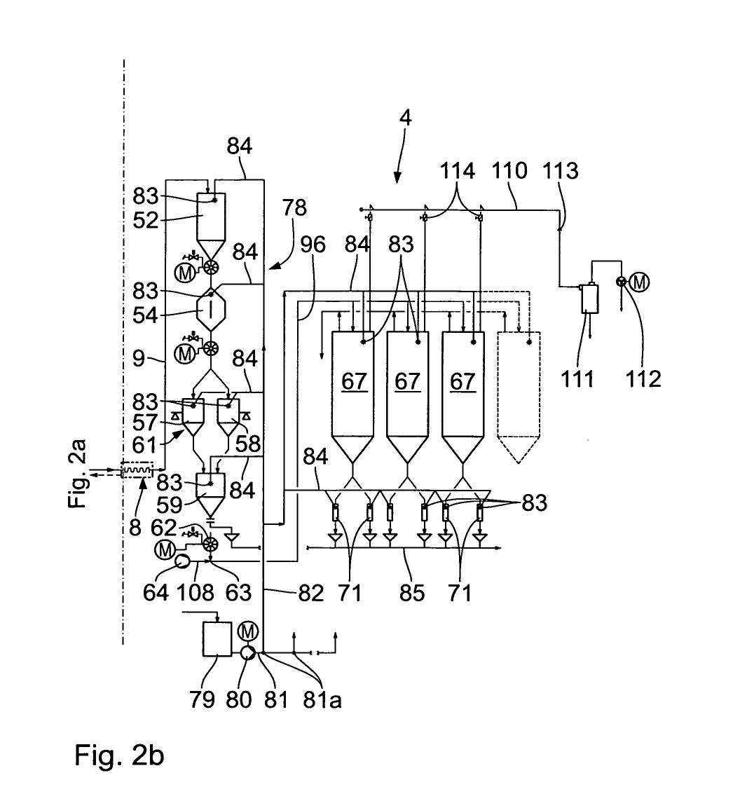

Instead of conveying lines or conveying pipes that are individual or arranged next to one another in a row as in the embodiments shown above, a plurality of conveying pipes may also be guided in a pipe package of conveying pipes between the various conveying components of the loading system 1 and/or the unloading system 4, 94. Various designs of pipe packages of this type will be described below with the aid of FIGS. 4 to 9. FIGS. 4 to 9 in each case show a cross section through the respective pipe package.

FIG. 4 shows a conveying pipe package 115 with conveying pipes 116, which are grouped around a common support frame 117. The support frame 117 has a central support pipe 118, which is reinforced by means of an inner profile structure 119 with reinforcement and profile structures. The profile structure 119 may also be a component of a coupling mechanism for the support frame 117. The conveying pipes 116 are arranged equally distributed in the peripheral direction around the support pipe 118.

In the configuration according to FIG. 4, five of the conveying pipes 116 are present with a nominal width in the range of between 200 mm and 350 mm, in particular in the region of 300 mm Other nominal widths are also possible. In embodiments of the package 115 not shown, three, four, six, seven, eight, nine or even more of the conveying pipes 116 may be grouped in the peripheral direction around the support frame 117.

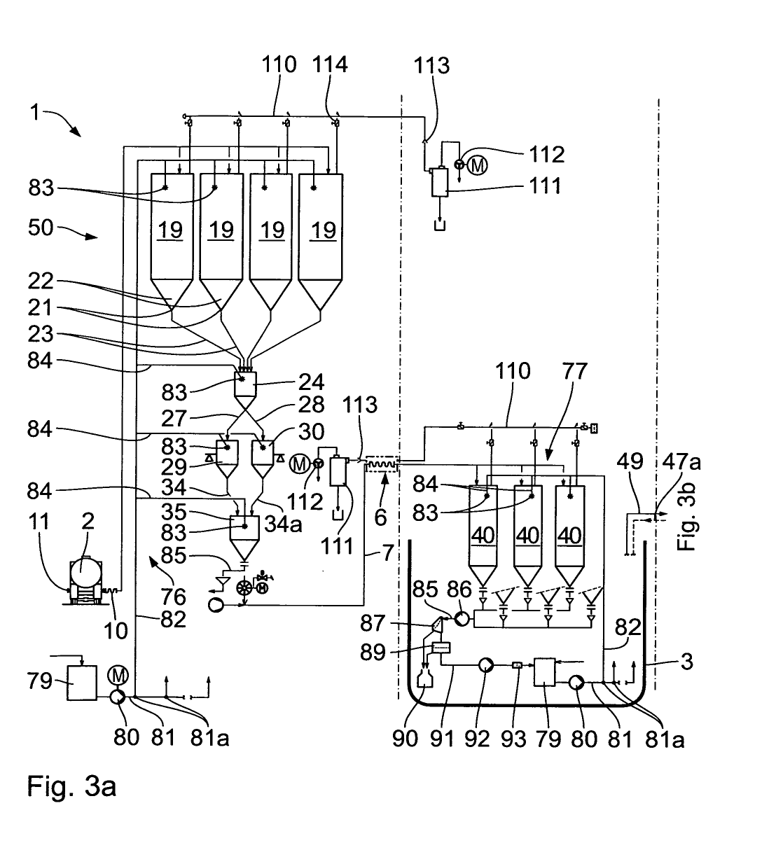

FIG. 5 shows a variant of a conveying pipe package 120, in which the support frame 117 is configured as a rectangular profile. Four of the conveying pipes 116, which are held, in a manner not shown, by the support frame 117, for example by means of connecting struts, are grouped around the support frame 117 in the manner of a 2×2 array.

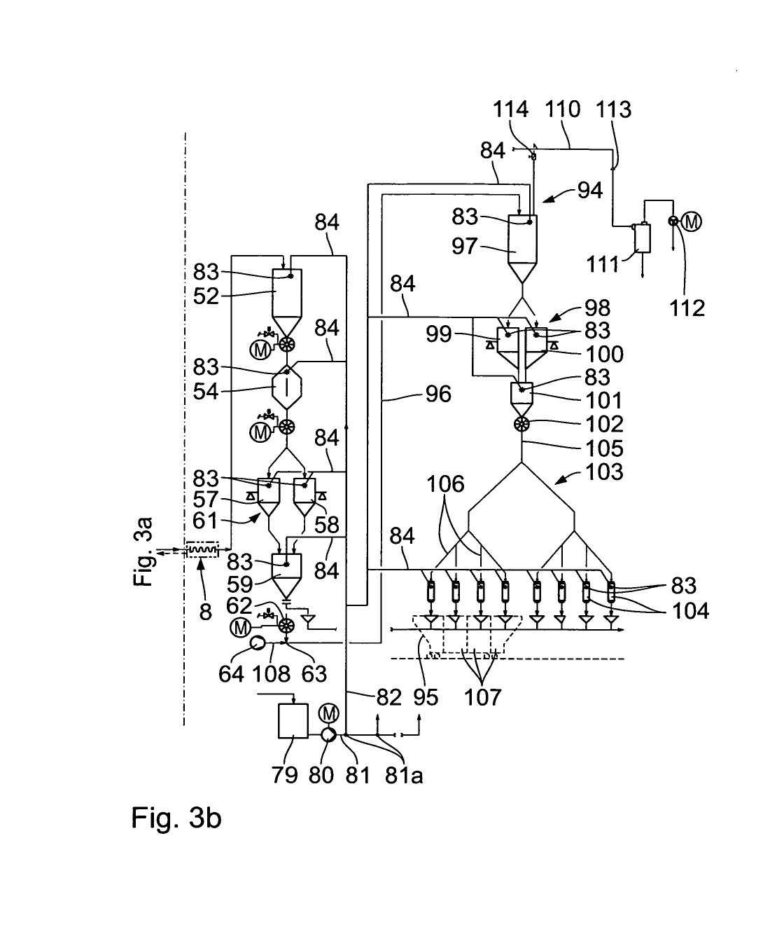

FIG. 6 shows a further configuration of a conveying pipe package 121. Two rows 122, 123 of the conveying pipes 116 are arranged there offset with respect to one another by half the spacing of two conveying pipes 116. Each of the rows 122, 123 comprises four of the conveying pipes 116. A different number of conveying pipes within one of the rows 122, 123 is also possible. The two conveying pipe rows 122, 123 are both carried by the support frame 117 by means of struts, not shown. The support frame 117, which is in turn configured as a rectangular profile, is arranged above the two conveying pipe rows 122, 123 in the configuration according to FIG. 6.

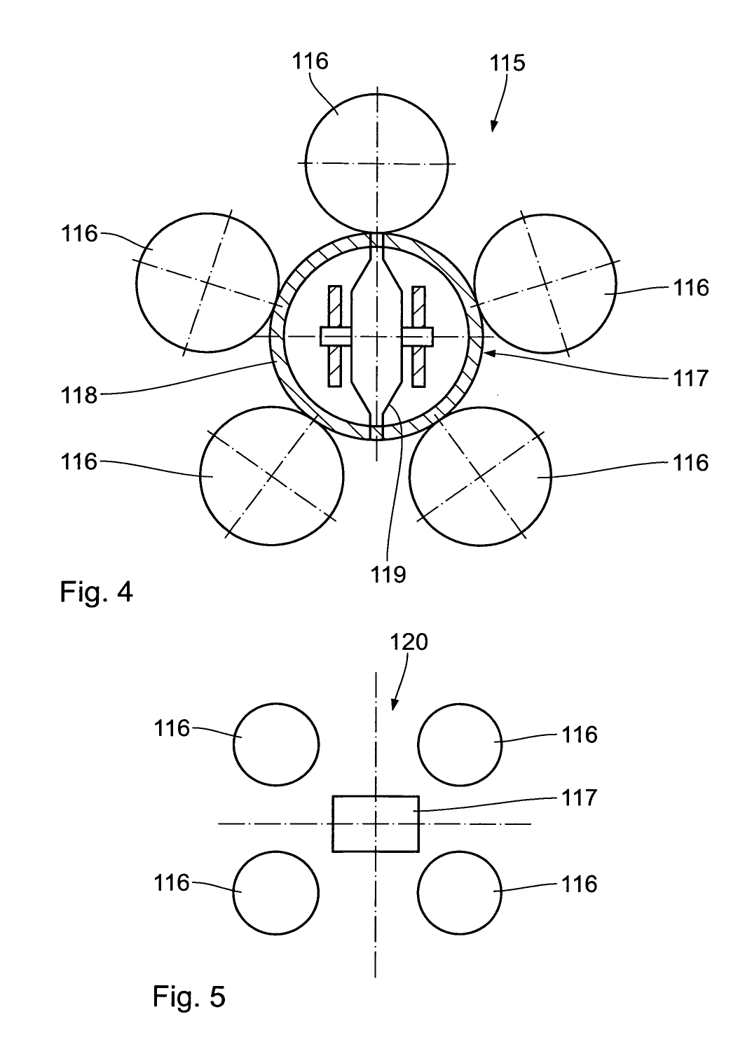

FIG. 7 shows a further configuration of a conveying pipe package 124. Five of the conveying pipes 116 are arranged like the eyes of the dice number “five”. The conveying pipes 116 are carried by a support frame 117 again configured as a rectangular profile, which, in the configuration according to FIG. 7, is arranged below the central conveying pipe 116.

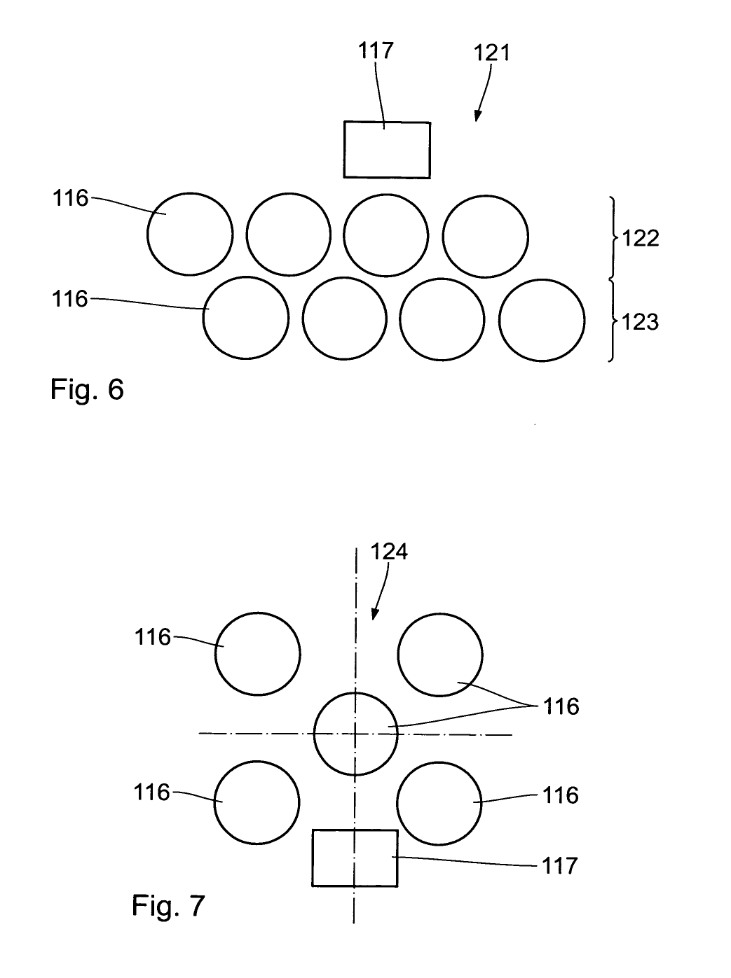

FIG. 8 shows a further configuration of a conveying pipe package 125. In total, the package 125 has nine conveying pipes 116, which are arranged in the manner of a 3×3 array, which in the arrangement according to FIG. 8, is rhombic in cross section. The conveying pipes 116 in the configuration according to FIG. 8 are carried by means of a support frame 117, which is in turn configured as a rectangular profile and is arranged close to a conveying pipe 116 on the corner side in relation to the 3×3 array in the configuration according to FIG. 8. The course of the main connecting struts 126 to connect the conveying pipes 116 to the support frame 117 is shown by dash-dot lines in FIG. 8. Other connecting struts have been omitted.

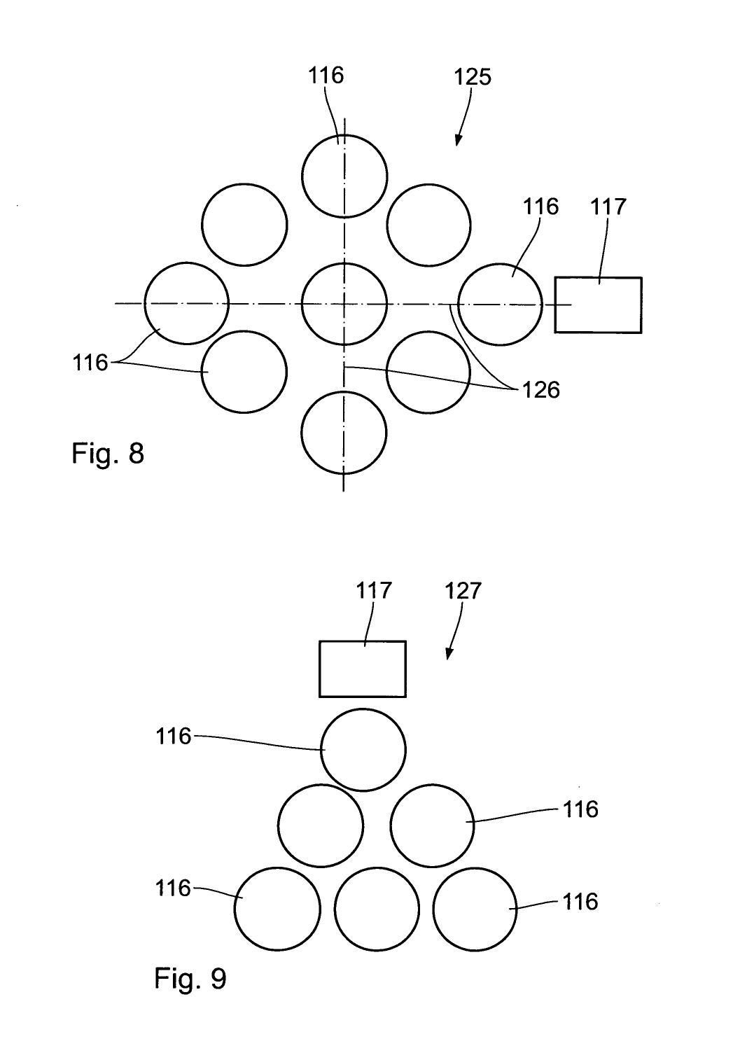

FIG. 9 shows a further configuration of a conveying pipe package 127. This has a total of six conveying pipes 116, which are arranged hexagonally, in an approximately triangular manner, closely packed in the total package cross section in such a way that three of the conveying pipes 116 are arranged in a base row, two of the conveying pipes 116 are arranged in a row above it and one of the conveying pipes 116 is arranged on the support frame side and again thereabove. The support frame 117 is in turn configured as a rectangular profile in the configuration according to FIG. 9.

In the configurations according to FIGS. 4 to 9, in principle, the respective support frame 117 can also be dispensed with if the conveying pipes 116 of the respective conveying pipe package are connected to one another in a self-supporting manner.

Alternatively, conveying pipes of the loading or unloading system, respectively, may be arranged horizontally side by side to each other in one row. Above or below such a conveying pipe row a support frame according to the support frame 117 described above may be arranged to support such conveying pipe row. Such row may have four, five, six, eight or more conveying pipes.

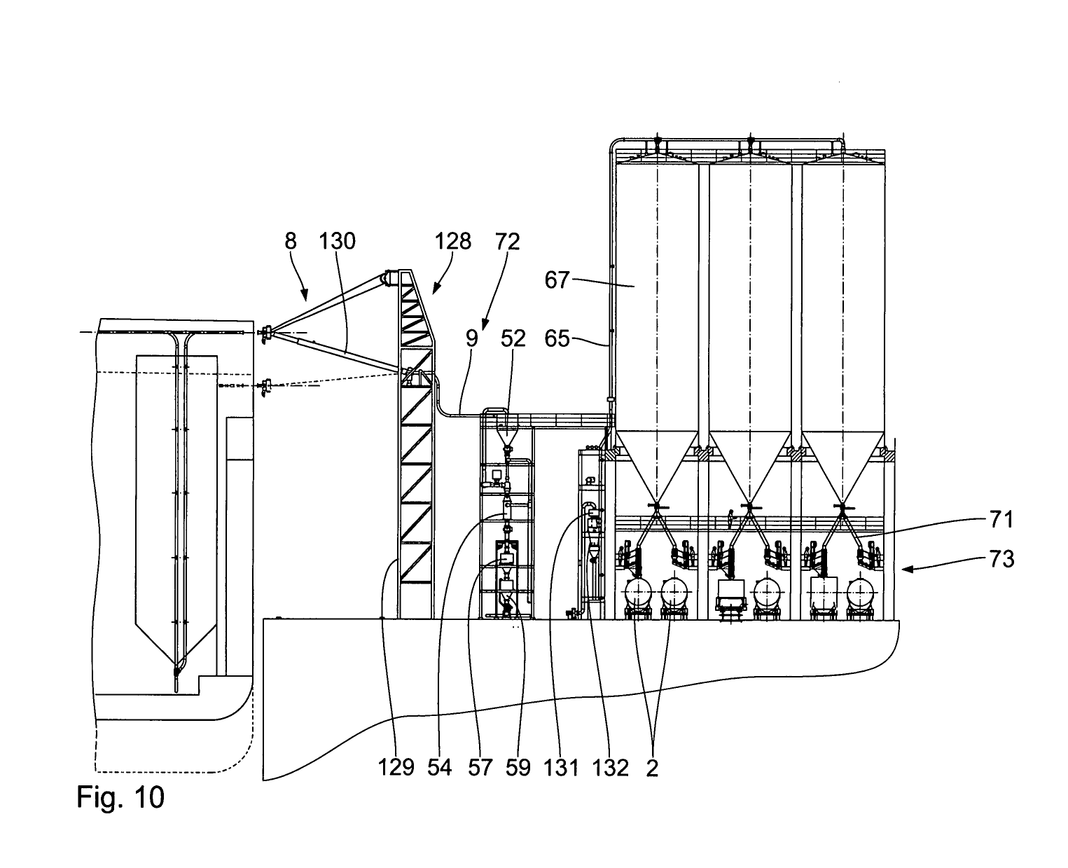

An unloading system 128, which can be used, for example, instead of the above-described unloading systems 4 and 94, is described below with the aid of FIG. 10. Components, which correspond to those which have already been described with reference to FIGS. 1 to 9 and, in particular, with reference to FIGS. 1 to 3, have the same reference numerals and will not be discussed again in detail.

The unloading system 128 has a conveying tower 129. This is a component of the ship to shore conveying device 8.

A conveying pipe 130 has a conveying connection to the conveying line 9, which is in turn connected to the preliminary container or intermediate storage container 52. The sifter mechanism 54 is in conveying connection to the exit of the conveying container 52. Arranged downstream of said sifter mechanism with a conveying connection is a weighing unit with a weighing container 57 and an intermediate storage container 59 for weighing the unloaded bulk material batch. A dust line 131 has a fluid connection to a cyclone 132, by means of which a removal of bulk material contained in carrier gas lines is possible. The conveying line 65 is arranged downstream of the weighing unit and has a bulk material conveying connection to the storage containers 67. From there, the bulk material can be fed via the delivery connections 71 to the transporters 2 in the form of lorries, freight trucks or railway wagons.

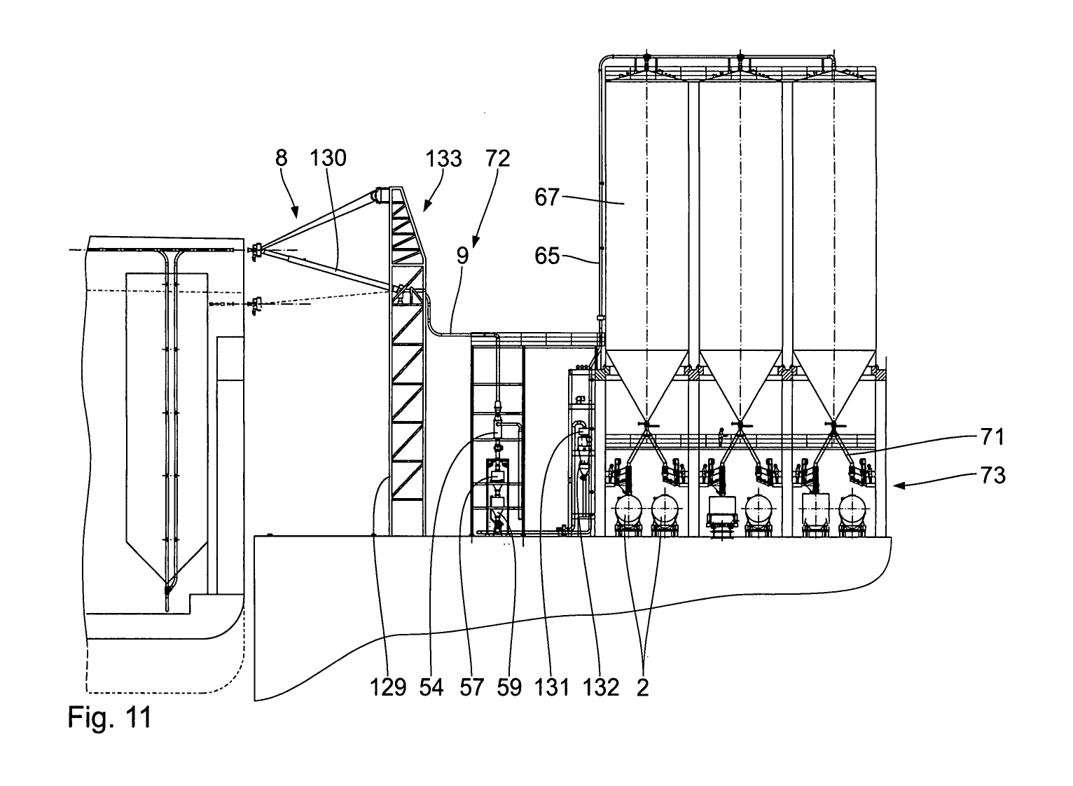

FIG. 11 shows a further configuration of an unloading system 133. The latter differs from the unloading system 128 according to FIG. 10 in that the conveying line 9 from the conveying tower 129 opens directly into the sifter mechanism 54. In the unloading system 133, the preliminary container 52 is therefore omitted.

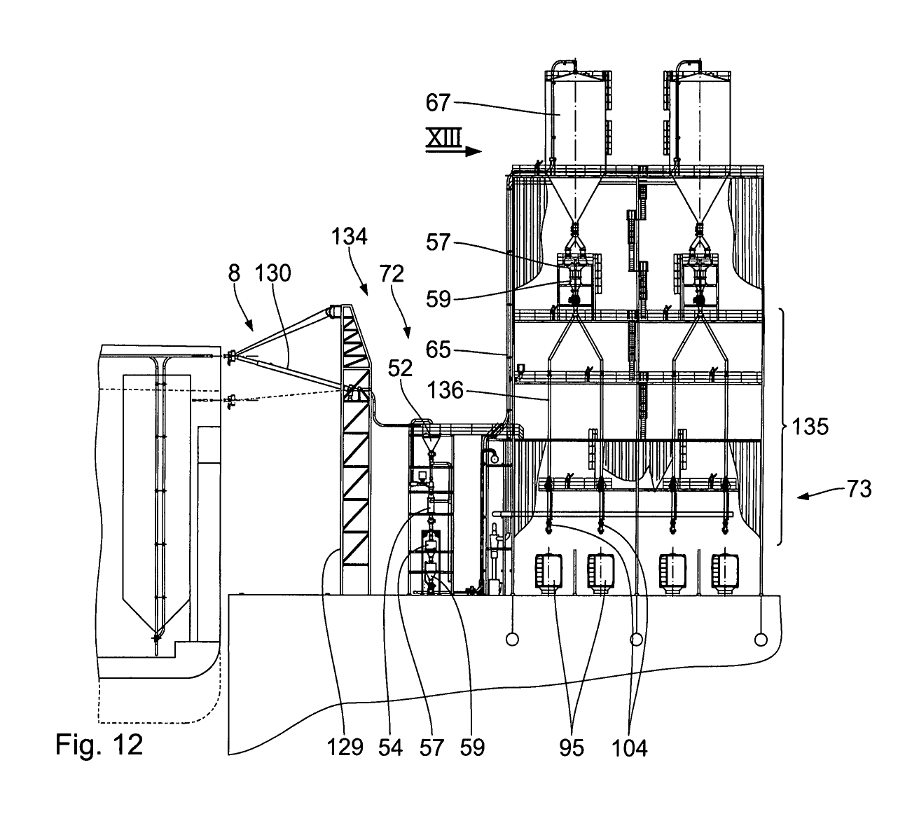

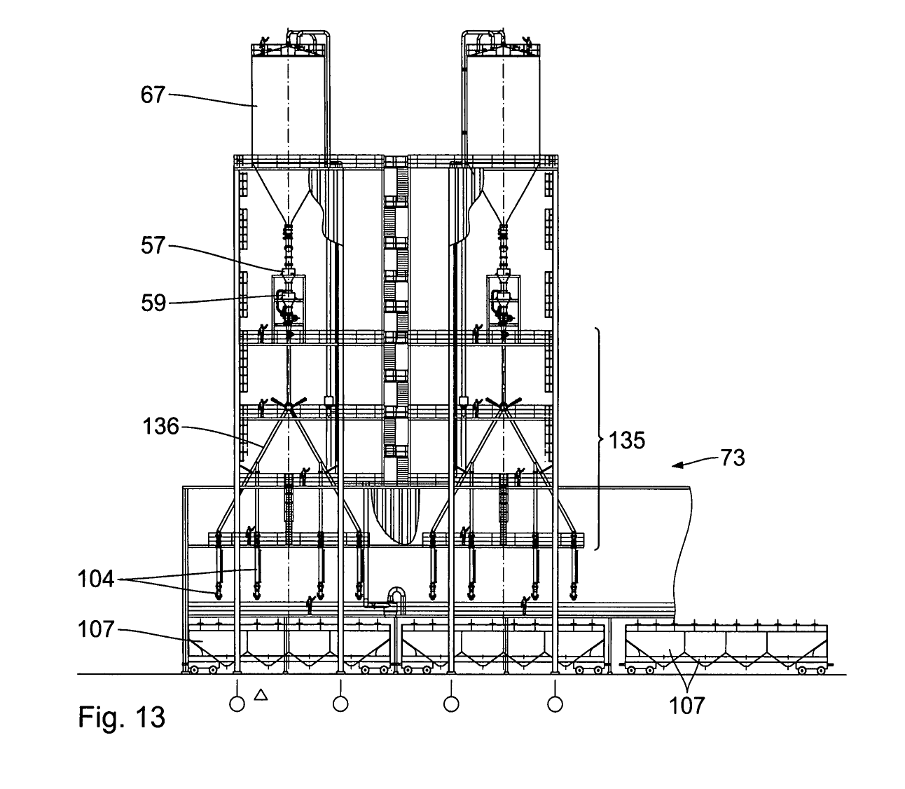

With the aid of FIGS. 12 and 13, a further configuration of an unloading system 134 will be described below, which can be used instead of the unloading systems 4, 94, 128 and 133. Components which correspond to those which have already been described above with reference to FIGS. 1 to 11, have the same reference numerals and will not be discussed again in detail.

Conveying components, weighing components and sifter components may be integral components of the conveying tower 129 to establish a compact arrangement. Further, the conveying tower 129 and/or a sifting device may be integrally arranged in a steel construction to carry e.g. loading or unloading side intermediate storage containers, e.g. the unloading side intermediate storage containers 67.

Up to the bulk material conveying line 65, the bulk material conveying path of the unloading system 134 corresponds to that of the unloading system 128. In the unloading system 134, respective weighing units, in turn with two weighing cells 57, 58 arranged one above the other, are arranged downstream in the bulk material conveying path from the intermediate storage containers 67. Arranged downstream from the weighing units in the bulk material conveying path are pipe distributor mechanisms, which distribute the bulk material, proceeding from the exit of the weighing units, in each case, into a plurality of, in the embodiment shown, into eight individual pipe lines 136. This distribution means that, in each case, one of the intermediate storage containers 67 can fill two wagons 95 arranged on tracks located next to one another by means of four respective delivery connections 104 in the loading chambers 107 thereof.

1. A loading system for loading bulk material from a bulk material production plant onto a ship, the system comprising:
at least one stationary intermediate storage container for receiving the bulk material from the bulk material production plant,
at least a first loading conveying device for conveying the bulk material into the intermediate storage container,
at least a second loading conveying device for conveying the bulk material from the intermediate storage container into the ship,
wherein at least one of
the first loading conveying device is configured in such a way that at least one of a slow conveyance, a dense phase conveyance and a lean phase conveyance of the bulk material takes place by means of the first loading conveying device and
the second loading conveying device is configured in such a way that at least one of a slow conveyance, a dense phase conveyance and a lean phase conveyance of the bulk material takes place by means of the second loading conveying device.

2. A loading system according to claim 1, comprising a weighing mechanism for weighing the bulk material before the conveyance into the ship.

3. An unloading system for loading bulk material from a ship onto transporters
at least one stationary intermediate storage container for receiving the bulk material from the ship;
at least a first unloading conveying device for conveying the bulk material from the ship to the intermediate storage container,
at least a second unloading conveying device for conveying the bulk material from the intermediate storage container into the transporters,
wherein at least one of
the first unloading conveying device is configured in such a way that at least one of a slow conveyance, a dense phase conveyance and a lean phase conveyance of the bulk material takes place by means of the first unloading conveying device and
the second unloading conveying device is configured in such a way that at least one of a slow conveyance, a dense phase conveyance and a lean phase conveyance of the bulk material takes place by means of the second unloading conveying device.

4. An unloading system according to claim 3, comprising a weighing mechanism for weighing the bulk material before conveyance into the transporters.

5. An unloading system according to claim 3, comprising a stationary control mechanism for controlling the first unloading conveying device.

6. A system according to claim 1, further comprising a cleaning mechanism for cleaning the at least one intermediate storage container.

7. A system according to claim 1, wherein the at least one intermediate storage container has a mixer insert.

8. A system according to claim 1, comprising a carrier air source for conveyance, which has a compressor network with a plurality of compressor mechanisms.

9. A system according to claim 8, wherein the carrier air source is configured to be so efficient that a loading of the intermediate storage container with bulk material and removal of bulk material from the intermediate storage container are possible in parallel.

10. A system according to claim 1, further comprising an emergency uncoupling mechanism for ensuring a connection which can be rapidly uncoupled in an emergency between the intermediate storage container and the ship.

11. A system according to claim 1, further comprising conveying lines, which extend at least one of
horizontally in an angle range between a 30° ascending gradient and a 45° descending gradient and
vertically in an angle range of maximum of a 30° deviation from the vertical.

12. A system according to claim 1, wherein at least one of the slow conveyance, the dense phase conveyance, and the lean phase conveyance of the bulk material takes place through a plurality of conveying pipes, which is guided in a pipe package of conveying pipes.

13. A system according to claim 1, further comprising a conditioning device for conditioning one of the group of carrier gas and carrier air in one of the group of the ship-side and harbour-side conveying components.

14. A system according to claim 1, further comprising at least one rotary valve as a conveying component of at least one of the first loading conveying device and the second loading conveying device.
